(19) United States
(12) Patent Application Publication
(10) Pub. No.: US 2012/0059732 A1
(43) Pub. Date: Mar. 8, 2012

(54) Online Marketplace

(75) Inventors: Wisam Dakka, New York, NY (US); Marcel M. Moti Yung, New York, NY (US)

(73) Assignee: GOOGLE INC., Mountain View, CA (US)

(21) Appl. No.: 12/876,725

(22) Filed: Sep. 7, 2010

(51) Int. Cl. G06Q 30/00

(52) U.S. Cl. 705/26.4; 705/27.1

(57) ABSTRACT

Methods, systems, and apparatus, including computer programs encoded on a computer storage medium, for facilitating aggregated market transactions. In one aspect, a method includes receiving inventory data from sellers, where the inventory data specifies an ask price for a particular product and a discount function associated with the product. User input is received from users, where the user input requests information about a particular product. In response to the user input, data are provided that cause presentation of a product request user interface. Bids for the particular product are received from multiple users, and a final price is selected using ask prices, discount function, and bids. In turn, the particular product is allocated to a set of users that specified a bid that meets the final price.

### BACKGROUND

This specification relates to data processing and online transactions.

The Internet provides access to a wide variety of resources. For example, video and/or audio files, as well as web pages for particular subjects or particular news articles are accessible over the Internet. Access to these resources presents opportunities for retailers to market and sell products to users. For example, a web page can include advertisement slots in which advertisements can be presented. These advertisements slots can be defined in the web page or defined for presentation with a web page, for example, in a pop-up window. Users that select (i.e., click on) an advertisement presented in an advertisement slot can be redirected to a retailer's web page where the user can purchase products from the retailer.

Many users that purchase products online research the products prior to their purchase. For example, these users may submit one or more search queries to a search engine in an effort to receive information about products that they are interested in buying. Users may also indicate an interest in products by clicking on advertisements and/or by posting information about the product in a social network setting. At any given time, there may be a large number of users that are interested in purchasing a particular product and are researching the particular product. However, these users are generally unaware of the other users that are interested in purchasing the product and, therefore, cannot coordinate their purchases to obtain volume discounts that retailers may be willing to offer to “bulk” purchasers.

### SUMMARY

In general, one innovative aspect of the subject matter described in this specification can be embodied in methods that include the actions of receiving inventory data from one or more sellers, the inventory data from each seller specifying an available quantity of a particular product, an ask price for the particular product, and a discount function associated with the product, the discount function specifying a discount offered by the seller upon satisfaction of a discount condition; receiving user input from a plurality of users, the user input for each user specifying that the user is requesting information about the particular product; providing data that cause presentation, to each of the users, of a product request user interface that includes information about the particular product and a bid submission element; receiving bids from the plurality of users, each respective bid specifying a price that a respective user will pay for the particular product, each bid also being associated with a unit quantity that specifies a quantity of the particular product that the user will purchase; selecting a final price for the particular product using the ask prices for the product, a total quantity of the particular product requested by the users, and the discount functions; and allocating the particular product to a set of users at the final price, each user in the set of users being associated with a bid that meets the final price. Other embodiments of this aspect include corresponding systems, apparatus, and computer programs, configured to perform the actions of the methods, encoded on computer storage devices.

These and other embodiments can each optionally include one or more of the following features. Providing data that cause presentation of the user interface can include providing data that cause presentation of a user interface that includes a current purchase price that is computed using the ask prices for the particular product. Methods can further include receiving purchase data specifying that a particular user has requested to purchase the particular product at the current purchase price; and allocating the particular product to the particular user at the current purchase price.

Receiving inventory data can include receiving, from at least one seller, inventory data specifying a discount function that is a function of sales volume over a specified time period. Receiving user input can include receiving a search query that is associated with the particular product; and providing data that cause presentation of the user interface can include providing data that cause presentation of the user interface in a search results page, the user interface further comprising one or more product configuration elements with which configuration options for the particular product are selected.

Selecting a final price for the particular product can include selecting, for each of the sellers, a source quantity specifying an amount of the total quantity to be provided by the seller; computing, for each of the sellers, a source discount using the discount function for the seller and the source quantity; computing, for each of the sellers, a source cost using the source quantity, the ask price for the seller, and the source discount; computing a total source cost for the total quantity of the particular product using the source cost for each of the sellers; and selecting the final price based on a function of the total cost and the total quantity.

Selecting a source quantity for each of the sellers can include selecting a source quantity for each of the sellers using the available quantity specified by the seller and the ask price specified by the seller. Selecting a source quantity for each of the sellers can include selecting a highest source quantity for a seller that is associated with a lowest ask price. Selecting a source quantity for each of the sellers comprises selecting a highest source quantity for a seller that is associated with a lowest discounted price that is computed using the ask price associated with the seller and the discount function associated with the seller.

Methods can further include providing each seller compensation having a value at least equal to the source cost associated with the seller. Selecting a final price can include selecting per-user final prices on a per-user basis, at least one of the per-user final prices being different than at least one other per-user final price. Selecting a final price can include selecting a final price based on an output value from an optimization technique that computes the output value based on the inventory data and the product request data. Receiving user input can include receiving at least one of text posted by the user at a social network environment and data representing a selection of an invitation to participate in an aggregated marketplace transaction.

Particular embodiments of the subject matter described in this specification can be implemented so as to realize one or more of the following advantages. A data processing can efficiently identify a set of users that are interested in purchasing a particular product and facilitate a bulk purchase for the set of users. A data processing apparatus can efficiently facilitate distribution products to the set of users at lower prices than the prices at which the individual users would otherwise be able to purchase the products from participating sellers by aggregating user requests for the products and facilitating a “bulk” purchase of the products. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which users purchase products from sellers.

FIG. 2 is a screen shot of an example search results page that includes a product request user interface.

FIG. 3 is a screen shot of an example market interface with which users can submit product requests.

FIG. 4 is a flow chart of an example process for facilitating aggregated market transactions.

FIG. 5 is a flow chart of an example process for selecting a final price for products allocated in aggregated market transactions.

FIG. 6 is block diagram of an example computer system that can be used to facilitate aggregated market transactions.

Like reference numbers and designations in the various drawings indicate like elements.

### DETAILED DESCRIPTION

This document describes aggregating user product requests to create an aggregated product request and fulfilling the aggregated product request by allocating available products from product inventory. For example, using an online user interface two or more independent users can independently request to purchase a particular product at a maximum specified price. As described below, each of the users' requests can be received by a data processing apparatus that combines the individual requests into an aggregated product request. The data processing apparatus then accesses inventory data to select available products that have been requested and determine a price at which the requested products will be sold to the users.

Typically, the price at which the products will be sold to the users will be a price between a market price at which the users could individually purchase the products directly from the sellers and a discounted price that the sellers will accept for the products to be distributed for aggregated product requests. The discounted price can be, for example, a price that is computed using discount functions specified by the sellers (e.g., volume discounts and/or individual product discounts). The discount functions can be submitted by the sellers using a computer (or another communications device). The sellers can update their discount functions and/or periodically be requested to provide updated discount functions.

Aggregating product requests and fulfilling those requests results in a more efficient allocation of products. For example, since the price that the users pay for a product is less than the price at which the users could otherwise independently purchase the product, users can realize a discount that they may not otherwise be eligible to receive. Similarly, by agreeing to distribute products to fulfill aggregated product requests, sellers can achieve higher sales volumes at lower per-transaction marketing costs.

The methods, systems, and apparatus for facilitating aggregated transactions are described with reference to a search environment. The description that follows is also applicable to aggregating product requests in social networking environments, online chat environments, as well as using client-side applications that are executed by computers or other data processing apparatus (e.g., mobile devices).

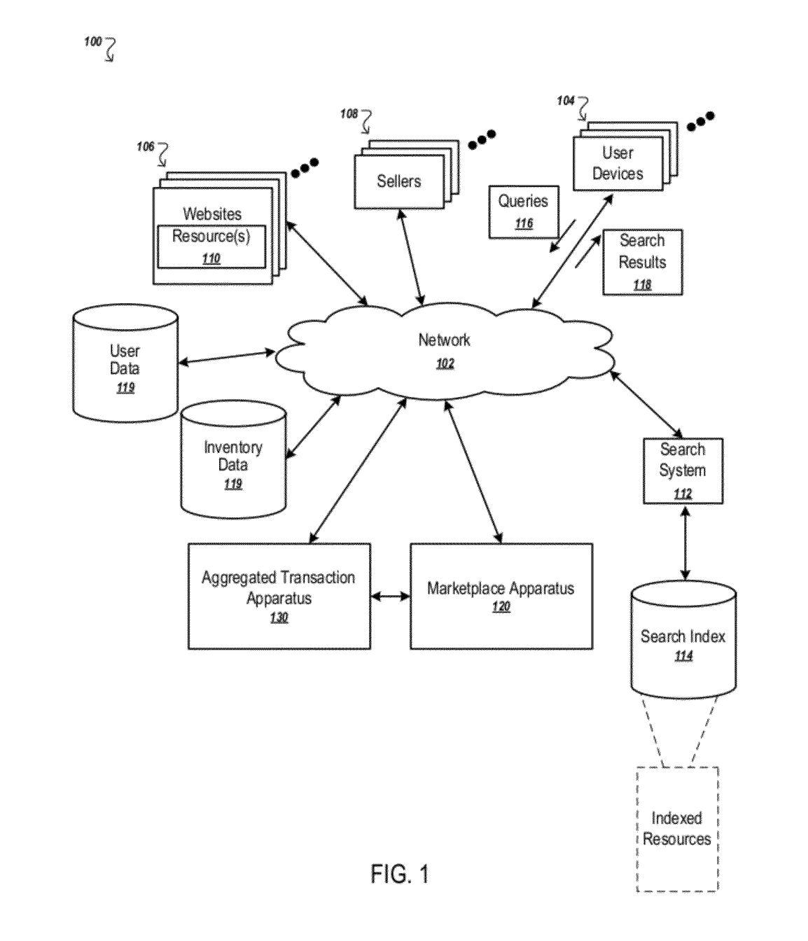

FIG. 1 is a block diagram of an example environment in which users research products and purchase products from sellers. For example, the environment 100 includes a network 102, such as a local area network (LAN), a wide area network (WAN), the Internet, or a combination thereof over which user devices 104 can access websites 106. Many of these websites 106 include resources 110 that provide information about products offered by sellers 108 as well as resources 110 with which users can interact to purchase products, services, or other products provided by the sellers 108. For example, as described in more detail below, users can utilize a search system 112 to research particular products. In turn, the user can request, from a seller's website, a web page that includes user interface elements that enable the user to select products that the user wants to purchase and provide payment information to purchase the products. The example environment 100 may include many thousands of user devices 104, websites 106, and sellers 108.

A website 104 is one or more resources 110 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104. For example, a seller 108 can be the publisher of a website that provides resources 110 with which a user can interact to purchase products from the seller 108.

A resource 110 is any data that can be provided over the network 102. A resource 110 is identified by a resource address that is associated with the resource 110. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts). Resources 110 can also include social network resources that facilitate communication between user devices that are accessing the social network resource.

A user device 104 is an electronic device that is under control of a user and is capable of requesting and receiving resources over the network 102. Example user devices 104 include personal computers, mobile communication devices, and other devices that can send and receive data over the network 102. A user device 104 typically includes a user application, such as a web browser, to facilitate the sending and receiving of data over the network 102. A user device 104 can request resources 110 from a website 106, for example, by entering a URL or other network location that is associated with the resource 110 into a web browser, or by the user clicking on a link that redirects the user device 104 to the URL or other network location that is associated with the resource. In turn, data representing the resource 110 can be provided to the user device 104 for presentation by the user device 104.

To facilitate searching of these resources 110, the environment 100 can include a search system 112 that identifies the resources 110 by crawling and indexing the resources 110 provided by the publishers on the websites 106. Data about the resources 110 can be indexed based on the resource 110 to which the data corresponds. The indexed and, optionally, cached copies of the resources 110 are stored in a search index 114.

User devices 104 can submit search queries 116 to the search system 112 over the network 102. In response, the search system 112 accesses the search index 114 to identify resources 110 that are relevant to the search query 116. The search system 112 identifies the resources 110 in the form of search results 118 and returns the search results 118 to the user devices 106 in search results pages. A search result 118 is data generated by the search system 112 that identifies a resource 110 that is responsive to a particular search query, and includes a link to the resource 110. An example search result 118 can include a web page title, a snippet of text or a portion of an image extracted from the web page, and the URL of the web page. Search results pages can also include one or more advertisement slots in which advertisements can be presented.

Users that are interested in a particular product may research the particular product by submitting one or more search queries to the search system 112 in an effort to identify information that will assist the user in determining whether to purchase the product. For example, a user that is interested in purchasing a laptop computer may submit search queries such as “laptop computer,” “cheap laptop,” “Brand X laptop.” In response to each of these search queries, the user may be provided search results 118 that have been identified as responsive to the search query. The user can then select one or more of the search results 118 to request presentation of a web page or other resource 110 that is referenced by a URL associated with the search result.

Additionally, the search results pages that are presented to the user in response to these queries may include advertisements that have been selected as responsive to the search queries. For example, in response to the search query “laptop computer,” an advertisement for “Seller A” that sells laptop computers may be presented with the search results page that is provided to the user. If the user selects (i.e., clicks) the advertisement for Seller A, the user's device can be redirected, for example, to a web page provided for Seller A. This web page can include, for example, information about a laptop computer that Seller A sells, a price at which Seller A will sell the laptop computer, and user interface elements that enable the user to specify a quantity of laptop computers that the user will buy, as well as payment information and shipping information required to complete the transaction

In some implementations, the seller's website includes all of the resources 110 that are required to complete the transaction. For example, the seller's website may include web pages that enable the user to add products to an electronic “shopping cart,” enter payment and/or shipping information. Additionally, the seller's website may include code that completes financial transactions (i.e., credit card transaction, online payment transactions, or other financial transactions).

In other implementations, the seller's web page includes code that references a marketplace apparatus 120 that is used to complete the transaction. The marketplace apparatus is a data processing apparatus that is configured to facilitate sales transactions between buyers and sellers over the network 102. The marketplace apparatus can be configured to provide electronic “shopping carts,” perform financial transactions, provide transaction confirmation data to the buyer and/or seller, and/or provide shipment tracking information.

For example, a seller's web page may include code that causes a checkout user interface element (e.g., a checkout button) to be presented to the user. In response to the user clicking on the checkout user interface element, checkout data can be provided to the marketplace apparatus 120 indicating that the user is ready to complete a purchase. The checkout data can include product identifiers specifying the products that the user has selected to purchase, quantities of each product that the user has selected to purchase, and prices associated with the selected products. In response to receipt of the checkout data, the marketplace apparatus can obtain payment and shipping information from the user (or the seller), complete the transaction, and provide confirmation data to each of the seller 108 and the user device 104 confirming the details of the transaction. In some implementations, the checkout data includes the payment and shipping information.

While the marketplace apparatus can help facilitate transactions between users and sellers 108, each transaction between each user and each seller is generally performed independent of other transactions that may be occurring between other users and sellers. For example, within a one-hour period, hundreds or thousands of different users may be researching a same particular product (e.g., a laptop computer) and/or purchasing the particular product from a same or a different seller 108. In this example, each of the buyers is generally unaware of the quantity of other users that are researching and/or purchasing that particular product, and sellers may similarly be unaware of the quantity of users that are researching and/or buying that particular product.

When each of the users independently purchases a product, there is no opportunity for the users to aggregate their purchases in order to obtain discounts that may be offered by sellers to obtain a “bulk” purchase of the particular product (i.e., a purchase of at least a pre-specified threshold quantity of the particular product). Similarly, when each of the sellers independently sells the particular product, each individual seller is constantly competing for sales with other sellers, such that it is more costly to obtain sales. For example, in order to sell one unit of the particular product to an individual user, the seller generally must spend money on advertising campaigns or otherwise attract the user to the sellers' website and have the user complete the transaction using the seller's website. Therefore, when selling a product to a single user, sellers are generally less willing to reduce their prices than they may otherwise be if they were selling a much larger quantity of the product (e.g., 10 times more quantity).

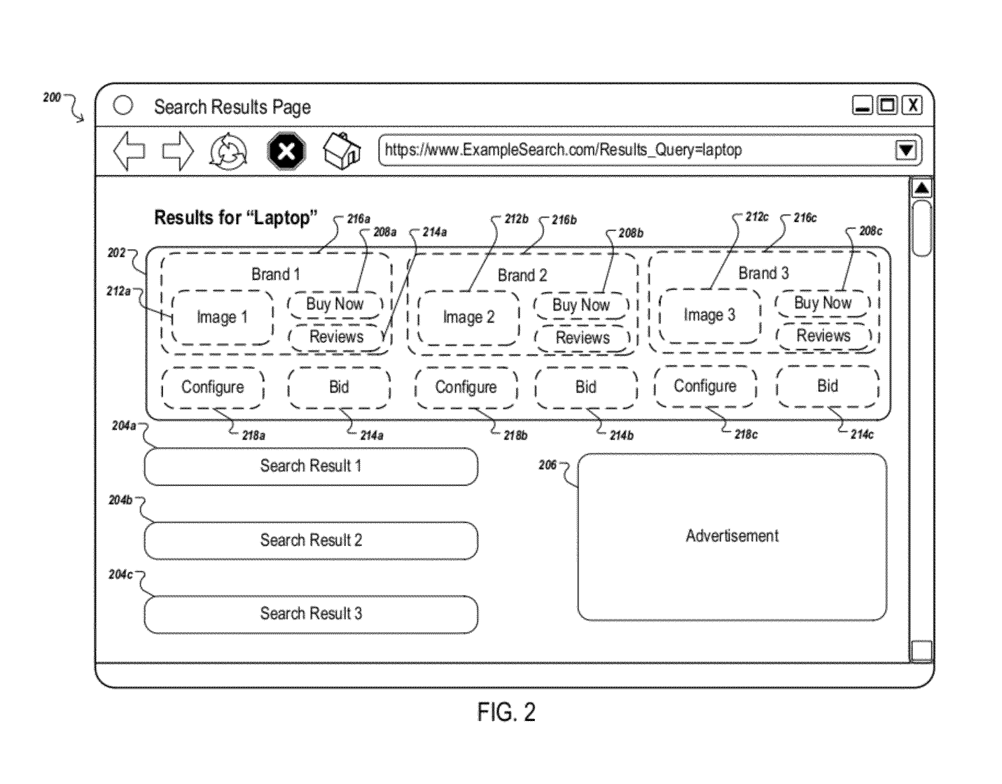

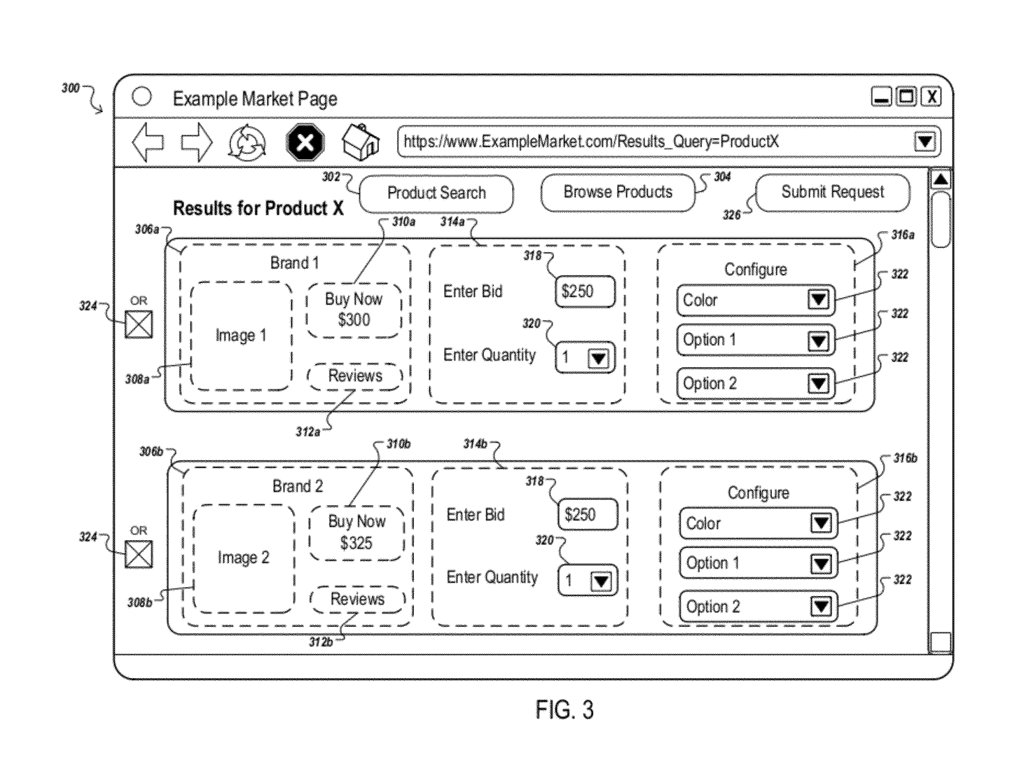

The environment 100 includes an aggregated transaction apparatus 130 (“ATA”) that aggregates product request data (also referred to as “product requests”) received from users and allocates, to the users, products from one or more sellers based on inventory data that has been received from the one or more sellers. In some implementations, the product request data received from each user is data that specifies one or more particular products that the user will buy, a quantity of the particular product that the user will buy, and a bid (i.e., a maximum price at which the user will purchase the particular product). The bid can be a per-unit bid that specifies a price that the user will pay for each unit of the particular product (e.g., $300 for each laptop) or a per-order bid that specifies a maximum price that the user will pay for the specified quantity of the particular product (e.g., $700 for 3 laptops). As described with reference to FIGS. 2 and 3, product request data can be received from users through a product request user interface that is presented with a search results page and/or a market interface through which users submit product requests.

In some implementations, product request data can also be received from users that are interacting in a social network environment. For example, the social networking environment can include an ATA 130 that determines, based on communications between a set of users, that the users have expressed an interest in (or are otherwise discussing) products. In response to this determination, the ATA 130 (or the social networking environment) can cause presentation of a market interface or another user interface through which the users submit product requests.

Inventory data is data received from a seller that specifies one or more products (i.e., products and/or services) that the seller is offering for sale, a quantity of each particular product that the seller will sell, an ask price for each particular product, and a discount function that is associated with each particular product. An ask price is a price at which the seller will sell a single unit of a product independent of a discount function. For example, a seller may specify that a laptop computer has an ask price of $400, such that the seller will sell a single laptop computer for $400. In some implementations, the seller can be required to commit to provide the products at the prices specified in the inventory data.

A discount function that is associated with a particular product (or group of products) specifies a discount offered by the seller upon satisfaction of one or more discount conditions. In some implementations, the discount function can be represented by a discount schedule that specifies, for example, discounts that the seller is offering in response to different sales volumes being achieved. For example, table 1 provides an example discount schedule specified by Seller A.

TABLE 1

| Monthly Sales Volume ($) | Discount |
|---|---|
| 100,000 | 1% |
| 500,000 | 5% |
| 1,000,000 | 12% |

According to Table 1, Seller A will provide increasing discounts when sales of $100,000, $500,000, and $1,000,000 are respectively achieved within a single month. For example, the discount that the seller will provide for products sold through the ATA 130 in March 2011 will be 5% if the value of products sold through the ATA 130 in February 2011 were between $500,000 and $999,999. The discount schedule of Table 1 specifies price discounts that are directly proportional to a dollar volume of sales that were achieved in a prior month. Discount schedules can also specify discounts that are proportional to a unit volume of products sold, discounts that are effective upon achievement of a sales volume during a current month (e.g., 5% discount for remainder of month once sales exceed $250,000), and/or discounts based on an average unit price of products sold (e.g., 10% discount for products over $1,000 ask price when total order is greater than $100,000).

Discount functions can also specify “package discounts” that specify a discount that the seller is offering for purchases of two or more particular products in a single order (i.e., a package). For example, a particular seller may specify that the ask price for product X is $100 and the ask price for product Y is $80, but that the advertiser will sell a package that includes both product X and product Y for $150, which is $30 cheaper than the cost of buying products X and Y separately. In this example, the seller is offering a $30 package discount for each pair of product X and product Y that are sold together.

When sellers specify package discounts, the ATA 130 can realize additional savings by aggregating product requests from users that are requesting either product X or product Y, but not both. For example, if 50 users are requesting product X alone, 40 users are requesting product Y alone, and 30 users are requesting product X and Y, the ATA 130 can aggregate the requests into 70 requests for the package of product X and product Y and 10 requests for product X alone. In this example, the total cost of the products is $11,500 (i.e., 70*$150+10*$100), which is $1,200 cheaper than the products would have otherwise cost if the requests were not aggregated (i.e., 50*$100+40*80+30*$150=12,700).

A discount function can also specify exception conditions that are discount conditions that limit the availability of otherwise available discounts. For example, an exception condition can specify that particular volume discounts are invalid for specified products (e.g., product Z) and/or products that have less than a threshold unit price (e.g., products under $30 ask price).

In some implementations, the ATA 130 aggregates product requests over a pre-specified time period (e.g., 1 hour, 2 hours, or 1 day) or until a pre-specified volume of product requests have been received for a particular product. For example, the ATA 130 can continue to aggregate product requests specifying a particular product (e.g., a laptop computer) until at least 100 units of the particular product have been requested by users.

Once the ATA 130 has completed aggregating the product requests, the ATA 130 computes a final price at which the particular product will be sold to one or more of the users that requested the particular product. In some implementations, the final price is computed as a function of the ask prices for the particular product that have been received from the sellers and the discount functions associated with the respective sellers. The ATA 130 can also use the quantities of the particular product that have been requested by the users and the bids received from the users to compute the final price (or user-specific final prices, where at least one user pays a different price than another user), as described in more detail below.

In some implementations, the ATA 130 computes a total discount that can be realized for the aggregated product requests using an optimization algorithm, such as a linear or dynamic programming optimization algorithm. The optimization algorithm provides, as output, a near maximum (or maximum) discount that can be provided based on the product request data and the inventory data. The ATA 130 can compute, for example, a maximum discount that can be achieved, while ensuring that at least a threshold portion of the users are allocated a product. The ATA 130 can also be implemented to maximize a number of users that will be allocated products, while ensuring that the discount received for the products is within a specified threshold of the maximum discount available.

In some implementations, an optimization function can be used to compute the total discount and/or the final price. For example, “dynamic programming” and “linear programming” are known optimization techniques that can be used to the total discount and/or final price. Additionally, the ATA 130 can use combinatorial optimization techniques to compute the total discount and/or final price.

For example, the total discount and/or final price can be set to a value that maximizes matching in a bipartite graph. The items to be sold can be represented by one side of the graph's nodes and the aggregated product requests can be represented by the nodes on the other side of the graph. A single edge can be used to pair a node that represents an item to be sold and a particular product request. The weight of each edge is set to a value that represents a difference between the bid associated with the product request and a price associated with the item. A maximum matching can be determined by performing a maximum matching technique using the graph. The maximum matching technique selects a matching that substantially maximizes a difference between an aggregate cost to the users and an aggregate of the ask prices for the items. This difference can be defined as the total discount. This technique is also referred to as a double-auction technique.

The ATA 130 can use the total discount output by the optimization algorithm to determine a per-unit final price that will be charged for each unit of the particular product, and allocates the products to the users at the final price. In some implementations, the per-unit final price is computed using a per-unit ask price for the products being allocated and an average per-unit source cost for the products. A source cost is a value paid to a seller for a product. The total source cost for the total quantity of products is a total value paid to sellers that provided the total quantity of products, and the average per-unit source cost is a ratio of the total source cost and the total quantity of products allocated.

For example, assume that 150 products were provided to 150 users, and that Seller A and Seller B provided 100 and 50 of the products, respectively. Further assume that the source cost of the 100 products provided by Seller A was $3,100, while the source cost of the 50 products provided by Seller B was $1,400. In this example, the total source cost of the 150 products that were provided to the users is $4,500. If the ask price per-unit product provided by Seller A was $40, and the ask price per-unit product provided by Seller B was $35, a total ask price for the 150 products would have been $5,750 (i.e., 50*$35+100*$40). Therefore, the ATA 130 has realized a total discount of $1,250 for the products relative to the total ask price at which the 150 products would have been sold individually.

The ATA 130 shares the total discount with the 150 users that requested the product by selecting a per-unit final price that is between a per-unit source cost (i.e., $4500/150) and the per-unit ask price (i.e., $5,750/150). For example, the ATA 130 may select a final price of $33, such that the users realize a per-unit discount of $5.33 and an entity that provides and/or operates the ATA 130 realizes revenue of $3.00 per-unit. In some implementations, the ATA 130 (i.e., an entity that operates the ATA) can also share a portion of the total discount with the sellers 108. For example, the ATA 130 may share 10% of its realized revenue (e.g., $0.30/unit) with the sellers 108 as part of a revenue sharing agreement.

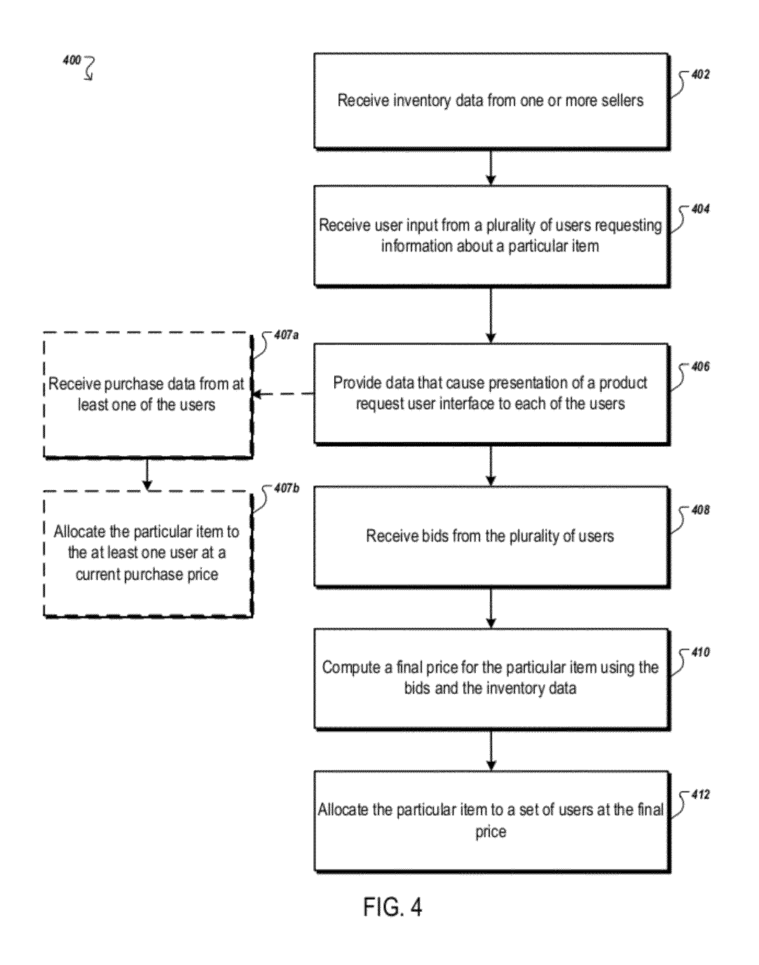

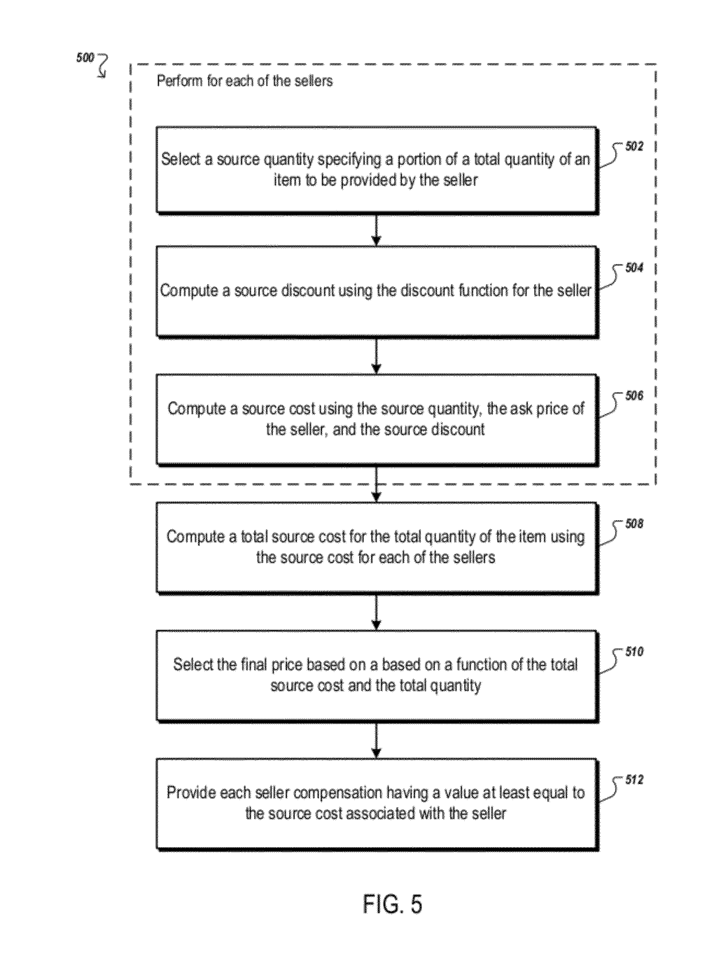

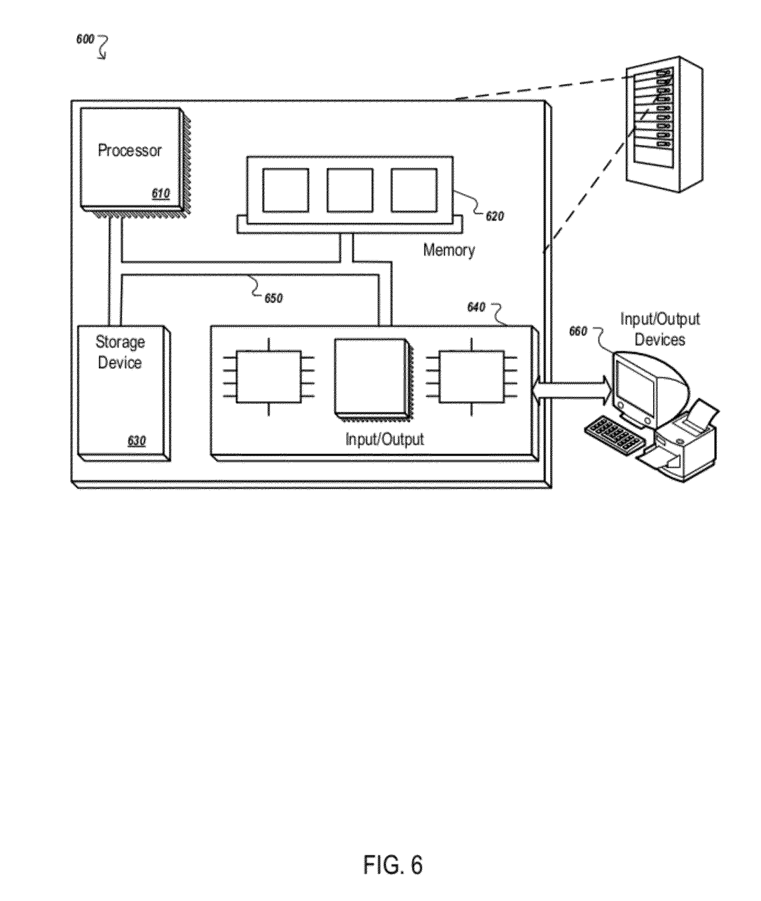

User interfaces and processes that can be used to facilitate aggregated market transactions are described below. For example, user interfaces that can be used to facilitate receipt of product request data are described with reference to FIGS. 2 and 3, while an example process for facilitating aggregated market transactions is provided with reference to FIG. 4. An example process for selecting a final price is described with reference to FIG. 5, and an example computer system that can be used to facilitate aggregated market transactions is described with reference to FIG. 6

FIG. 2 is a screen shot of an example search results page 200 that includes a product request user interface 202. The search results page 200 includes three search results 204a-204c that were identified as responsive to the search query “Laptop.” For example, the search results 204a-204c may include links to web pages that review laptops, retailers that sell laptops, and/or technical articles discussing laptops, and/or a social networking environments in which users are exchanging messages about laptops. The search results page 200 can also include an advertisement 206 that has been selected as relevant to the search query “laptop.” For example, the advertisement may be an advertisement to a retail store that sells laptop computers.

Search result pages can also be presented in response to user interaction with other applications that provide search functionality. For example, search results pages similar to that provided in FIG. 2 can be presented in response to a user searching user messages in a social networking environment. In this example, the search results may include links to the “threads” in which discussions relevant to the search query have been identified (e.g., a social network discussion page where the words “buy” and “laptop” are presented.

The search results page 200 also includes a product user interface 202 in which product information 216a-216c is presented. The product user interface 202 is a user interface with which a user can interact to specify a product that the user is interested in purchasing and/or a price that the user will pay for the product. For example, the product user interface 202 can include “buy now” elements 208a-208c that upon user selection submits purchase data specifying that the user has requested to purchase a particular product at a current purchase price (e.g., a market price). The product user interface 202 can also include review elements 210a-210c that upon user selection request presentation of user reviews for a particular product. The product user interface 202 can further include information about the particular products, such as images of the products 212a-212c, text describing the products, or other information (e.g., a current purchase price for the product).

The product user interface further includes bid elements 214a-214c that enable a user to specify a price that the user is willing to pay for one or more of the products. In some implementations, a bid element 214 is an interactive button that upon user selection causes presentation of a bid environment in which the user inputs the price that they will pay for the product and/or a quantity of the product that the user will buy. In other implementations, the bid element 214 includes one or more text boxes in which the user can enter price and quantity information. Once the user has specified a bid and requested quantity for a product, the user can select a submission element that causes submission of product request data including the price and quantity information.

The products for which information is provided by the product user interface 202 are products that have been identified as responsive to the search query that was most recently entered and/or a series of search queries that the user has submitted (e.g., during a single search session and/or day or over many different search sessions and/or days). For example, in response to the search query “laptop” the product user interface 202 may present product information 216a-216c for three different brands of laptop computers. The three brands of laptop computers for which the information 216a-216c are provided can be, for example, brands of laptops that are available for purchase according to inventory data that have been provided by one or more sellers. In this example, the current purchase price for each brand of laptop can be the ask price that has been specified by the seller of that brand of laptop. Alternatively, one or more of the current purchase prices can be a discounted price based on a discount function that is associated with the seller that is providing the laptop.

In some implementations, the products that have been identified as responsive to the search query can be selected based on previous user actions by users that previously entered the search queries and/or based on other information that has been obtained about the user (e.g., from a user profile). Products that are responsive to a particular search query can include those products that were purchased by users that, prior to the purchase, entered search queries similar to the current search query (or series of search queries). For example, a statistical analysis of the search queries submitted by users that purchased the products can be used to select products that were most often purchased (or purchased with at least a minimum threshold frequency) following submission of search queries that are similar to the current search query (e.g., where the similarity is based on co-sine similarity measures or other measures of similarity).

In some implementations, the product user interface 202 includes product configuration elements 218a-218c that enable a user to select product options. For example, product configuration elements 218a-218c can be buttons that upon selection by a user cause presentation of a configuration interface. The user can then interact with the configuration interface to select product options such as a product color, product size, and/or other product options. In other implementations, the configuration interface can be presented in the product configuration element, such that a user can directly configure their product without having to first select a button. In these implementations, the product configuration elements 218a-218c can each include, for example, drop-down elements that upon selection present available product options and enable a user to select configuration options, as illustrated by FIG. 3.

Once a user has finished configuring products that they would like to purchase, the user can select one of the “buy now” elements 208a-208c or one of the bid elements 214a-214c to request purchase of the product as configured using the configure elements 218a-218c and at the price specified by the user (e.g., using a bid element 214 or using a buy now element 208a-208c).

FIG. 3 is a screen shot of an example market interface 300 with which users can submit product requests. The example market interface 300 can be implemented, for example, to enable users to specify one or more products that they are interested in buying as well as prices at which the users will buy the one or more products. For example, the market interface 300 can include a product search element 302 and a product browse element 304.

The product search element 302 is a user interface element that enables a user to search inventory data to identify products. For example, the product search element can include (or cause presentation of) a text box in which the user can enter one or more words. In response to submission of the one or more words, products that are responsive to the one or more words can be presented in the market interface 300. The products that are responsive to the one or more words can be selected in a manner similar to the manner by which products responsive to search queries are selected.

The product browse element 304 is a user interface element that enables a user to browse products that are referenced by the inventory data. For example, selection of the product browse element 304 can cause presentation of references to products that are available for purchase. The product references can be grouped, for example, by product categories, product model numbers, product brands, or other references to groups of products that are available for sale according to the inventory data. The user can browse the groups of products and select one or more products and/or groups of products for presentation in the market interface 300.

The market interface can include product information 306a, 306b for products that are either responsive to the one or more words entered by the user or selected for presentation by the user using the product browse element 304, as described above. Similar to the search results page described with reference to FIG. 2, the product information 306a, 306b can include images of the products 308a, 308b, buy now elements 310a, 310b and review elements 312a, 312b. The market interface 300 can also include bid elements 314a, 314b and product configuration elements 316a, 316b that are respectively associated with the product information 306a, 306b.

The bid elements 314a, 314b each include a text box 318 in which a user can enter a price at which the user will buy the product that is associated with the product information 306a, 306b. The bid elements 314a, 314b also include a quantity element 320 that enables the user to specify a quantity of products that the user will buy at the price entered at the text box 318. The configure elements 316a, 316b each include drop down option selection boxes 322 that enable a user to customize the products that they are requesting to purchase.

In some implementations, the market interface 300 includes product election elements 324 that enable a user to specify which of the products that the user will buy when the user has submitted product requests for multiple products. For example, user selection of both product election elements 324 can specify that the user will only purchase one of the products that the user has requested. In this example, the product purchased by the user can be the product that is offered at the lowest total price or that is being offered at the highest discount (e.g., absolute value discount or percentage discount). Alternatively, the user can be enabled to specify a product preference that indicates an order in which the user prefers the requested products, such that the user can be allocated the highest preferred product in the event that the user is selected to be allocated two or more different products. If neither of the product election elements 324 is selected, the user will be allocated each product for which the user has submitted a product request.

Once the user has completed configuring products, the user can submit product request data using a submit request element 326. In response to user selection of the submit request element 326, the user device provides the product request data, for example, to the ATA 130 of FIG. 1. The ATA 130 aggregates the product request data from the user with product request data received from other users and then allocates products to users by matching an available quantity of products specified by the inventory data to product requests that are requesting the available products, for example, using an optimization function that computes a maximum discount for the requested products based on the product request data and the inventory data.

FIG. 4 is a flow chart of an example process 400 for facilitating aggregated market transactions. The process 400 is a process by which inventory data and user input requesting information about a particular product are received. Data that cause presentation of a product request user interface are provided in response to the user input. Bids for the particular product are received from a plurality of users and a final price is computed for the particular product using the bids and the inventory data. The particular product is allocated to a set of users at the final price.

The process 400 is described below with reference to aggregating requests for an individual product over a specified period of time. The process 400 can also be used to aggregate requests for multiple products or related products that are available for allocation. For example, a process similar to the process 400 can be used to aggregate requests for two or more different products that are offered by one or more sellers. A process similar to the process 400 can also be used to aggregate requests for two or more different products that can be combined into a “package request” (i.e., a request for two or more different products) to achieve a higher discount (e.g., a package discount), as described with reference to FIG. 1. A process similar to that of 400 can also be used to aggregate requests and soliciting data from sellers once the request have been aggregated. For example, sellers can be provided with an aggregated product requests and asked to provide a proposal (e.g., a price quote) for fulfilling some or all of the aggregated request.

The process 400 can be implemented, for example, using the ATA 130 and/or marketplace apparatus 120 of FIG. 1. The process can also be implemented as instructions stored on computer storage medium such that execution of the instructions by data processing apparatus cause the data processing apparatus to perform the operations of the process 400.

Inventory data are received from one or more sellers (402). Each of the sellers can be online retailers, manufacturers, resellers, or other entities that have inventory for sale. The inventory data from each seller specifies an available quantity of one or more products that the seller will provide. The inventory data from each seller also specify an ask price for each product that the seller will provide.

As described with reference to FIG. 1, the inventory data further specify a discount function that specifies a discount offered by the seller and conditions that must be satisfied for a buyer to receive the discount. In some implementations, the inventory data can specify the discount function as a function of sales volume over a specified period of time. For example, as described with reference to FIG. 1, the amount of discount can be proportional to a value of products purchased over a previous week, month, or year. In other implementations, the discount function can be a function of a current transaction value and/or a function of a discount that is associated with a particular being requested.

The inventory data are stored in a data store, such as the inventory data store 119 of FIG. 1. In some implementations, the inventory data are indexed according to (i.e., associated with) at least one of a seller from which the inventory data were received and/or one or more products referenced by the inventory data.

User input is received from a plurality of users, each user input requesting information about a particular product (404). In some implementations, the user input received from each user is a search query and/or a string of search queries that the user has submitted to a search engine and/or a market interface (or a social networking environment), as described above with reference to FIGS. 1-3. The user input from each user can be received over a pre-specified period of time and/or until a sufficient quantity of product requests have been received, as described below.

Data are provided that cause presentation of a product request user interface that includes product information about the particular product for which information was requested (406). In some implementations, the data that cause presentation of the product request user interface are provided to a particular user in response to determining that the particular user is likely to be researching a product that the particular user intends to purchase. In some situations, a single search query can sufficiently indicate that a user is interested in purchasing a particular product, while in other situations; multiple search queries are received prior to determining that the user is interested in purchasing a product.

For example, the individual search query “cheap laptop computers” may have been previously received from a statistically significant quantity of users that purchased a laptop computer following submission of the search query. Therefore, receipt of the search query “cheap laptop computers” may alone be a sufficient indication that the user from whom the search query was received is likely to be requesting data about a product that the user is interested in purchasing.

In another example, a user may initially submit the search query “Computer Support,” which alone may not sufficiently indicate that the user that submitted the search query is researching a product to purchase. For example, analysis of user browsing history data may indicate that the search query “Computer Support” was received from a relatively equal number of users that were searching for technical assistance contact information or documentation related to Brand X computers (e.g., users that didn't subsequently purchase a computer-related product) and users that were researching a product to purchase (e.g., users that subsequently purchased a computer-related product). However, the analysis may also reveal that users that submitted search queries for “Computer Support,” followed by the search query “Brand X Computer,” often purchased a Brand X Computer. Therefore, user submission of “Computer Support,” followed by “Brand X Computer” can be indicative of a user that is researching a product to purchase.

As described above, user interactions with a social networking environment can also cause presentation of a product request user interface. For example, the user may participate in a social discussion within a social network discussion group, where the subject of the discussion and key words in the discussion may indicate that users participating in the discussion are potentially interested in purchasing a particular product. Alternatively, “friends” (i.e., users that have “connected” in a social network environment) can invite other users to participate in an aggregated purchased. In this example, a user may receive an explicit invitation and/or link that upon selection causes presentation of the product request user interface.

As described above with reference to FIGS. 2-3, the data that cause presentation of the product request user interface include data that cause presentation of the product request user interface in a search results page. The data can also include data that cause presentation of a bid element. Additionally, the data that cause presentation of the product request user interface can include data that cause presentation of a user interface that includes a current purchase price (i.e., a buy now price) for a product. In some implementations, the current purchase price is the ask price that is specified by the inventory data. In other implementations, the current purchase price is a discounted price relative to the ask price.

Each of the users that are presented a user interface that includes both a bid element and a current purchase price can independently select whether to submit a bid or to purchase the product at the current purchase price. Therefore, when the product request user interface includes a current purchase price, the process 400 optionally receives purchase data from at least one of the users (407a). The purchase data is received, for example, in response to user selection of a buy now element that is associated with the current purchase price. The purchase data includes data specifying that a particular user has requested to purchase the particular product at the current purchase price. The purchase data can specify a quantity of the particular product that the user has requested to purchase as well as configuration data specifying one or more configuration options that the users has selected for the product.

In response to receiving the purchase data, the particular product is allocated to the users from which purchase data were received (407b). The particular product is typically allocated to the users at the current purchase price. For example, a sales transaction between each the users from which the purchase data were received and the seller(s) that are offering the product can be completed following receipt of the purchase data. Completion of the transaction will generally require the user to pay the current purchase price for the particular product and the seller to provide the particular product. As described above, the purchase data can include all of the information (e.g., payment and/or shipping information) necessary to complete sales transactions, or additional information can be requested, for example, by a market apparatus that is configured to complete sales transactions.

Bids are received from users to whom the product request user interface was presented (408). In some implementations, each respective bid specifies a price that a respective user will pay for a particular product. For example, one user may submit a bid specifying that the user will pay $260 for a Brand X laptop, while another user may submit a bid specifying that the user will pay $240 for a Brand X laptop, and a third user may submit a bid specifying that the user will pay $265 for a Brand X laptop.

Each bid can be associated with a unit quantity that specifies a quantity of the particular product that the user will purchase. For example, the bid of $260 may be associated with a unit quantity of 5, indicating that the user that submitted the $260 bid is requesting to purchase 5 Brand X laptops for $260 each. Similarly, the bids of $240 and $265 may each be associated with a unit quantity of 1.

Using the bids and the inventory data, a final price is computed for the particular product (410). In some implementations, the final price can be computed using one of the optimization techniques described above. For example, the final prices can be computed using, as input to the optimization technique the ask prices specified by sellers that have offered to provide the product, a total quantity of the product requested by users, and discount functions associated with the sellers that have offered to provide the product. Computation of the final price is described in more detail with reference to FIG. 5.

In some implementations, the final price is computed using bids that have been received over a request interval. A request interval specifies one or more periods over which product requests for a particular product (or set of products) will be aggregated. For example, a request interval for Brand X laptop computers may be set as a daily interval, such that every 24 hours the bids that have been received for Brand X computers are used to compute a final price at which Brand X laptops will be allocated to the users from which product requests for Brand X laptops were received. Alternatively, a final price can be computed in response to the occurrence of a particular event. For example, a final price may be computed for Generic Tennis Rackets in response to receiving two or more product requests that request at least a pre-specified volume (e.g., 1,000) of Generic Tennis Rackets.

The particular product is allocated, for the final price, to a set of the plurality of users from whom bids were received (412). In some implementations, the set of users to whom the particular product is allocated to the users that provided a bid equal to or greater than the final price for the particular product. Continuing with the example above, assume that the final price for Brand X laptops was $260. In this example, the user that requested 5 Brand X Laptops for $260 each will be allocated 5 Brand X laptops and will pay $260 each. Similarly, the user that requested a single Brand X laptop for $265 will be allocated a Brand X laptop and will pay $260 for the laptop. However, the user that requested a Brand X laptop for $240 will not be allocated a Brand X laptop.

FIG. 5 is a flow chart of an example process 500 for selecting a final price for products allocated in aggregated market transactions. The process 500 is a process by which a source quantity is selected, where the source quantity specifies a quantity of products being provided by the seller. A source discount is computed using the discount function associated with the seller and a source cost is computed using the source discount and the ask price for the seller. A total source cost is computed using the source costs for each of the sellers that are providing products. The final price is computed using a function of the total cost and the total quantity of products being allocated. In turn, each seller is compensated a value at least equal to the source cost that that is associated with the seller.

The process 500 can be implemented, for example, using the ATA 130 and/or marketplace apparatus 120 of FIG. 1. The process 500 can also be implemented as instructions stored on computer storage medium such that execution of the instructions by data processing apparatus cause the data processing apparatus to perform the operations of the process 500.

A source quantity specifying a portion of a total quantity of a product to be provided by the seller is selected (502). In some implementations, the total quantity specifies a quantity of a particular product that has been requested by users. For example, as described above, the total quantity can specify a total quantity of the particular product that has been requested over a request interval (e.g., a 24-hour period).

In some implementations, the total quantity can be selected using only product requests that are associated with a bid having a value that exceeds a minimum threshold bid. For example, assume that the ask price for a computer is $300, and that a product request is associated with a $1 bid. Further assume that each seller of the requested computer has specified that the computer is not available from any seller for less than $250 (including applicable discounts). In this example, the bid threshold may be set at $250 or some fraction of $250 (e.g., $250/1.2), since no laptops are available for less than $250. Using the bid threshold, the product request that is associated with the $1 bid may be filtered from the set of product request that are used to compute the total quantity because none of the sellers will sell the computer for less than $250.

Once the total quantity of products that have been requested by users is known, the source quantity for each of the sellers can be selected based on a total quantity of the requested product that is available from the seller, an ask price specified by the seller, and/or discount function that is associated with the seller. For example, assume that one seller can provide the total quantity of products and that this seller provides the product at a lowest total cost (i.e., including discounts). In this example, the source quantity for this one seller can be selected to be equal to the total quantity.

Although it is possible that the source quantity for a single seller can be set equal to the total quantity of products that have been requested by the users, often the total quantity requested will be greater than the quantity of the products that are available from a single seller. In these and other situations, the total quantity of products can be supplied by two or more sellers such that each of the sellers will provide a source quantity that is less than the total quantity. When two or more sellers are used to supply the total quantity of the product, the seller that is associated with a lowest ask price (or discounted price) can be (but is not required to be) the seller for which a highest source quantity is selected.

In some implementations, the source quantity can be selected using an optimization algorithm, as described above, that matches product requests to available inventory in a manner that maximizes the per-unit or overall discount (and/or minimizes the average per-unit source cost) for the quantity of products requested. The optimization algorithm can be constrained, for example, to ensure that not only the lowest priced sellers are selected to provide requested products. For example, the optimization algorithm can be required to select, for each aggregated product request, a minimum threshold source quantity (e.g., at least 10% of the total quantity) for a threshold quantity of sellers (e.g., 4 sellers).

Once a source quantity has been selected, a source discount is computed using the discount function associated with the seller (504). In some implementations, the source discount computed on a periodic basis, such that the same source discount is used over a specified period (e.g., 1 month). In other implementations, the discount function associated with the seller includes transaction dependent discounts that are computed on a per-transaction basis. For example, as described above with reference to FIG. 1, the discount function can specify particular discounts that are available or unavailable for particular products (e.g., products over a specified price) and/or package discounts for packages of two or more products. The source discount can be computed by summing the periodic discounts provided by the seller and the transaction dependent discounts.

Using the source quantity, the ask price of the seller, and the source discount, a source cost is computed for the seller (506). The source cost is a value paid to a seller for the products being provided by the seller. The source cost can be a total cost that is paid to the seller for the source quantity of the product. For example, assume that the source quantity for a particular seller that provides computers is 10 computers. In this example, the total price paid for the 10 computers is the source cost for the seller.

Process steps 502-506 can be iterative repeated (or performed in parallel) to select source quantities, compute source discounts, and compute source costs for multiple sellers. Once the iterative (or parallel) processing has been completed, the source costs for each of sellers are used to compute a total source cost for the total quantity of the product requested by the product requests (508). The total source cost can be computed, for example, as a sum of the source costs for each of the sellers that have been selected to provide the product.

The final price is selected based on a function of the total source cost and the total quantity (510). In some implementations, the final price is selected to be a price that is between a lowest winning bid and an average per-unit source cost for products (i.e., total source cost/total quantity of products allocated). A winning bid is a bid that is associated with a user that is being allocated a product. For purposes of example, assume that winning bids associated with a particular aggregated product request range from $12-$20, and the average per-unit source cost is $10. In this example the final price for each product may be selected to be $11.99, such that each of products will be sold to each user for $11.99. In some implementations, the final price may be set equal to the lowest winning bid.

Each seller is provided with compensation having a value that is at least equal to the source cost that was computed for the seller (512). In some implementations, the compensation provided to each seller is set exactly equal to the source cost associated with the seller. In other implementations, the seller may be provided with compensation that exceeds the source cost.

For example, each seller may be provided with a portion of the revenues that were generated based on the difference between the final price and the average per-unit source cost. In this example, each of the sellers can be provided the same portion of the revenues (e.g., an equal share of 10% of the revenues). Alternatively, each seller can be provided with a relative portion of the shared revenues, where each relative portion is proportional to a ratio of the average per-unit source cost for the product and a per-unit source cost (i.e., per-unit source cost=source cost/source quantity) that is associated with the seller. Continuing with the example above, if the average per-unit source cost is $10, and two sellers are respectively providing a particular product for $8 and $9, the seller that provides the product for $8 will receive a larger portion of the shared revenues than the seller that provides the product for $9 because 10/8 is larger than 10/9.

FIG. 6 is block diagram of an example computer system 600 that can be used to facilitate aggregated market transactions. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

What is claimed is:

1. A method performed by data processing apparatus, the method comprising:
receiving inventory data from one or more sellers, the inventory data from each seller specifying an available quantity of a particular product, an ask price for the particular product, and a discount function associated with the product, the discount function specifying a discount offered by the seller upon satisfaction of a discount condition;
receiving user input from a plurality of users, the user input for each user specifying that the user is requesting information about the particular product;
providing data that cause presentation, to each of the users, of a product request user interface that includes information about the particular product and a bid submission element;
receiving bids from the plurality of users, each respective bid specifying a price that a respective user will pay for the particular product, each bid also being associated with a unit quantity that specifies a quantity of the particular product that the user will purchase;
selecting a final price for the particular product using the ask prices for the product, a total quantity of the particular product requested by the users, and the discount functions; and
allocating the particular product to a set of users at the final price, each user in the set of users being associated with a bid that meets the final price.

2. The method of claim 1, wherein providing data that cause presentation of the user interface further comprises providing data that cause presentation of a user interface that includes a current purchase price that is computed using the ask prices for the particular product.

3. The method of claim 2, further comprising:
receiving purchase data specifying that a particular user has requested to purchase the particular product at the current purchase price; and
allocating the particular product to the particular user at the current purchase price.

4. The method of claim 1, wherein receiving inventory data comprises receiving, from at least one seller, inventory data specifying a discount function that is a function of sales volume over a specified time period.

5. The method of claim 1, wherein:
receiving user input comprises receiving a search query that is associated with the particular product; and
providing data that cause presentation of the user interface comprises providing data that cause presentation of the user interface in a search results page, the user interface further comprising one or more product configuration elements with which configuration options for the particular product are selected.

6. The method of claim 1, wherein
selecting a final price for the particular product comprises:
for each of the sellers:
selecting a source quantity specifying an amount of the total quantity to be provided by the seller;
computing a source discount using the discount function for the seller and the source quantity;
computing a source cost using the source quantity, the ask price for the seller, and the source discount;
computing a total source cost for the total quantity of the particular product using the source cost for each of the sellers; and
selecting the final price based on a function of the total cost and the total quantity.

7. The method of claim 6, wherein selecting a source quantity for each of the sellers comprises selecting a source quantity for each of the sellers using the available quantity specified by the seller and the ask price specified by the seller.

8. The method of claim 7, wherein selecting a source quantity for each of the sellers comprises selecting a highest source quantity for a seller that is associated with a lowest ask price.

9. The method of claim 7, wherein selecting a source quantity for each of the sellers comprises selecting a highest source quantity for a seller that is associated with a lowest discounted price that is computed using the ask price associated with the seller and the discount function associated with the seller.

10. The method of claim 6, further comprising providing each seller compensation having a value at least equal to the source cost associated with the seller.

11. The method of claim 1, wherein selecting a final price comprises selecting per-user final prices on a per-user basis, at least one of the per-user final prices being different than at least one other per-user final price.

12. The method of claim 1, wherein selecting a final price comprises selecting a final price based on an output value from an optimization technique that computes the output value based on the inventory data and the product request data.

13. The method of claim 1, wherein receiving user input comprises receiving at least one of text posted by the user at a social network environment and data representing a selection of an invitation to participate in an aggregated marketplace transaction.

14. A computer storage medium encoded with a computer program, the program comprising instructions that when executed by data processing apparatus cause the data processing apparatus to perform operations comprising:
receiving inventory data from one or more sellers, the inventory data from each seller specifying an available quantity of a particular product, an ask price for the particular product, and a discount function associated with the product, the discount function specifying a discount offered by the seller upon satisfaction of a discount condition;
receiving user input from a plurality of users, the user input for each user specifying that the user is requesting information about the particular product;
providing data that cause presentation, to each of the users, of a product request user interface that includes information about the particular product and a bid submission element;
receiving bids from the plurality of users, each respective bid specifying a price that a respective user will pay for the particular product, each bid also being associated with a unit quantity that specifies a quantity of the particular product that the user will purchase;
selecting a final price for the particular product using the ask prices for the product, a total quantity of the particular product requested by the users, and the discount functions; and
allocating the particular product to a set of users at the final price each user in the set of users being associated with a bid that meets the final price.

15. A system comprising:
a user device; and
one or more computers operable to interact with the device and to:
receive inventory data from one or more sellers, the inventory data from each seller specifying an available quantity of a particular product, an ask price for the particular product, and a discount function associated with the product, the discount function specifying a discount offered by the seller upon satisfaction of a discount condition;
receive user input from a plurality of users, the user input for each user specifying that the user is requesting information about the particular product;
providing data that cause presentation, to each of the users, of a product request user interface that includes information about the particular product and a bid submission element;
receive bids from the plurality of users, each respective bid specifying a price that a respective user will pay for the particular product, each bid also being associated with a unit quantity that specifies a quantity of the particular product that the user will purchase;
compute a final price for the particular product using the ask prices for the product, a total quantity of the particular product requested by the users, and the discount functions; and
allocate the particular product to a set of users at the final price, each user in the set of users being associated with a bid that meets the final price.

16. The system of claim 15, wherein the one or more computers are further operable to provide data that cause presentation of a user interface that includes a current purchase price that is computed using the ask prices for the particular product.

17. The method of claim 16, wherein the one or more computers are further operable to:
receive purchase data specifying that a particular user has requested to purchase the particular product at the current purchase price; and
allocate the particular product to the particular user at the current purchase price.

18. The method of claim 15, wherein the inventory data associated with at least one seller specify a discount function that is a function of sales volume over a specified time period.

19. The method of claim 15, wherein:
the user input is a search query associated with the particular product; and
the one or more computers are further operable to provide data that cause presentation of the user interface in a search results page, the user interface further comprising one or more product configuration elements with which configuration options for the particular product are selected.

20. The method of claim 15, wherein the one or more computers are further operable to select the final price by being operable to:
for each of the sellers:
select a source quantity specifying an amount of the total quantity to be provided by the seller;
compute a source discount using the discount function for the seller and the source quantity;
compute a source cost using the source quantity, the ask price for the seller, and the source discount;
compute a total source cost for the total quantity of the particular product using the source cost for each of the sellers; and
select the final price based on a function of the total cost and the total quantity.

21. The system of claim 15, wherein the one or more computers comprise a server operable to interact with the device through a data communication network, and the device is operable to interact with the server as a client.

22. The system of claim 15, wherein the user input is data posted at a social networking environment.

23. A method performed by data processing apparatus, the method comprising:
selecting a set of users, wherein each user in the set of users is associated with data indicating that the user will purchase a particular item at a respective price; and
brokering a group purchase for the set of users, the group purchase being a purchase of a total quantity of the particular item requested by the set of users at a per-unit price that is below at least one respective price.
